(19) United States
(12) Patent Application Publication
(10) Pub. No.: US 2012/0004865 A1
(43) Pub. Date: Jan. 5, 2012

(54) METHOD FOR MEASURING A FLUID VELOCITY AND RELATED APPARATUS

(75) Inventors: Giampiero Porro, Como (IT); Roberto Pozzi, Milano (IT); Alessandro Torinesi, Milano (IT); Michele Norgia, Pavia (IT); Luigi Rovati, Modena (IT)

(73) Assignee: DATAMED SRL, Rodano (MI) (IT)

(21) Appl. No.: 13/256,535

(22) PCT Filed: Mar. 15, 2010
(86) PCT No.: PCT/IB2010/051099

§ 371 Date: Sep. 14, 2011

(30) Foreign Application Priority Data
Mar. 16, 2009 (IT) MI2009A000400

(51) Int. Cl. G06F 19/00; G01P 5/26

(52) U.S. Cl. 702/49; 356/28.5

(57) ABSTRACT

A method for measuring the mean velocity (V_{H}) of an extracorporeal blood fluid or infusion fluid, by means of retroinjection interferometry, comprises the step of emitting a first laser light beam (41), from the laser cavity (40) of a semiconductor laser source (60), reflection of a second laser beam (45) by the fluid (50) and consequent generation of interference with the first laser beam (41) inside the laser cavity (40), detection of the interference signal by a monitoring photodiode (46), and processing, by means of an electronic processing and control circuit (100), of the interference signal detected. The invention also comprises an apparatus (62) for implementing the method described and an extracorporeal circuit (58) comprising said apparatus. The invention also comprises a method for replacing a laser source in said apparatus.

The present invention relates to a method for measuring the velocity of fluids, in particular infusion fluids, used generally in the sanitary field, or blood flowing in extracorporeal circuits, and the description which follows is provided with reference to this area of application solely in order to simplify illustration thereof. The invention also relates to the apparatus for implementing this method. Measuring the velocity of the fluid is useful for obtaining other important measurements such as the flowrate within a pipe.

### TECHNICAL BACKGROUND

Sensors without moving parts which make use of a number of physical parameters of the fluid, such as the temperature and pressure, for reflection of sound waves, or electrical charges for reflection of electromagnetic waves, are known. In the biomedical field, where measurements must be performed without affecting the sterility of the fluids being examined, it is necessary to have either sensors which can be sterilized, and therefore with low manufacturing costs compatible with the need for replacement after each successive examination, or sensors of the non-invasive type, which allow the measurement to be performed without coming into physical contact with the fluid.

In this specific field, ultrasound sensors (based on the reflection of sound waves) and optical sensors (based on the reflection of electromagnetic waves) are known. Ultrasound sensors can be used to measure the velocity of a fluid, but have major drawbacks:
the measurement is affected by variations in temperature;
the measurement depends on the geometric dimensions of the pipe;
in general, the cost for manufacture of ultrasound sensors is high.

The known optical sensors can be essentially classified as two types:
laser-doppler anemometers (FIG. 1) for measuring the velocity of a fluid;
semiconductor laser cavities (FIG. 5), for measuring displacements or vibrations of a target.

With reference to FIG. 1, a laser source 1 produces a monochromatic light beam 3. A prism 5 formed by birefringent crystalline material doubles the laser beam 1, producing two beams 3a, 3b which have identical wavelengths.

A lens 9 focuses the two laser beams 3a, 3b, causing them to converge at a point 11 within a pipe 13 having a fluid flowing inside it, the velocity of which is to be measured.

At the point 11, where the two laser beams 3a, 3b interact, interference fringes 13 are formed, i.e. alternately light and dark bands due to the respectively destructive and constructive interference of the two laser light beams 3a and 3b; this phenomenon is schematically shown in FIG. 2.

FIG. 3 shows, instead, a typical temporal progression of the light intensity I detected by a photomultiplier (not shown in the figure) in a laser-doppler anemometer, precisely focused on the point 11 where the two laser beams 3a, 3b meet. The photomultiplier measures an optical intensity peak whenever a particle passes within a constructive interference fringe. The signal output by the photomultiplier, i.e. the electric intensity I, therefore has peaks at regular intervals above a constantly present background noise, as shown in the said FIG. 3. If d refers to the known distance between two constructive interference fringes, the period of these peaks is expressed by:

$$Δτ = \frac{d}{u} \qquad ( 1.0 )$$

where u indicates the velocity of the suspended particle and therefore the fluid transporting it. As a result, since d and Δτ are known, u can be obtained. A spectral analysis of the signal output by the photomultiplier (FIG. 4) shows a peak at the frequency:

$$f = \frac{u}{d} \qquad ( 1.1 )$$

The main disadvantage of this measurement system is that it is not possible to distinguish the direction of flow of the fluid.

A Bragg cell 7 is therefore introduced in the laser-doppler anemometer and along the path of one of the two laser beams, as shown in FIG. 1.

The Bragg cell 7 causes a shift (typically equal to 40 MHz) in the frequency of the laser radiation of only one of the two laser beams 3a or 3b. This causes displacement of the corresponding interference fringe to 40 MHz; a particle stationary within the interference zone thus generates light peaks at the frequency 40 MHz in the photomultiplier.

When the fluid, and thus the suspended particles, is in movement, the so-called Doppler effect occurs: if the particle moves in the same direction as the interference fringes, there will be a smaller number of constructive interference zones per unit of time. The frequency of the pulses will therefore be less than:

f=f₀−Δf (1.2)

If, on the other hand, the movement of the particle occurs in the opposite direction to the movement of the interference fringes, the frequency of the signal output to the photomultiplier will be greater than:

f=f₀+Δf (1.3)

where in both cases Δf is a positive quantity which is expressed as:

$$Δ f = \frac{\vert u \vert}{d} \qquad ( 1.4 )$$

With the addition of the Bragg cell it is therefore possible to estimate the direction of movement of the fluid within the pipe and also an output signal is obtained even when the fluid is stationary.

The main disadvantages of this measurement system are as follows:
high costs due mainly to the Bragg cell and prism;
the time and qualified personnel needed for calibration of the system components; and
need for a fixed operating temperature necessary for optimum operation of the components.

The optical sensors known as semiconductor laser cavities comprise a laser source which generates coherent electromagnetic waves and have a simpler design than laser-doppler anemometers; they make a limited use of optics, are compact in size and are low-cost.

These sensors make use of retroinjection interferometry (called also feedback interferometry or backreflection interferometry).

Such an optical sensor is shown in FIG. 5, in which a laser cavity 23 emits a light beam 22 in the direction of a target (pipe 25); this beam is partly reflected by the fluid particles, and the light portion which returns into the laser cavity 23 from where it has been emitted interacts with the light emitted (so-called “self-mixing”), producing a fluctuation in the laser power.

This power fluctuation is detected using a photoreceiver 30 which normally forms an integral part of the laser assembly 20 and is positioned on the side of the cavity opposite to the pipe 25.

The laser may be operated with a constant current or the photoreceiver 30 may be used to stabilize the power emitted, acting by means of feedback on the current driving the laser.

If, at this point, the return light returns into the laser cavity, an interference is measured since it is mixed coherently with the radiation inside the laser itself. However, this technique is able to detect precisely only the displacement or the vibration of a target (the pipe 25 in the figure) and this target must be arranged at right angles to the incident laser beam.

The object of the present invention is to provide a method for measuring the velocity of extracorporeal blood fluids or infusion fluids which makes use of retroinjection interferometry and which is able to achieve the constructional advantages and simplicity of this technique.

### SUMMARY OF THE INVENTION

The object is achieved by a method for measuring the velocity of a fluid in accordance with that described in Claim 1.

The invention also relates to an apparatus for implementing this method, in accordance with that described in Claim 13.

The invention also relates to a method for replacing the laser source in accordance with that described in Claim 22.

The invention achieves the following main advantages:
determining the velocity of the fluid at a lower cost;
maximization of the backscattered power;
non-dependence on the type of semiconductor laser used;
possible regulation of the continuous power emitted by the laser;
operation with any monitoring photodiode; and
stability of the circuit also for capacitance values of the monitoring photodiode greater than 50 pF.

The features and further advantages of the invention will emerge from the description, provided hereinbelow, of an example of embodiment thereof provided by way of a non-limiting example, with reference to the accompanying drawings.

### BRIEF DESCRIPTION OF THE DRAWINGS

FIG. 1 shows a diagram of a laser-doppler anemometer according to the prior art;

FIG. 2 shows a known diagram for interference between two laser beams;

FIG. 3 shows the temporal progression of a parameter detected in the anemometer according to FIG. 1;

FIG. 4 shows a spectral analysis of the signal according to FIG. 3;

FIG. 5 shows a diagram of a semiconductor laser cavity according to the prior art;

FIG. 6 shows an apparatus which makes use of retroinjection interferometry according to the present invention;

FIG. 7 shows a circuit for detecting the interference signal included in the apparatus according to FIG. 6;

FIGS. 8 to 11 show temporal and spectral progressions of signals acquired by the circuit according to FIG. 7 at different fluid velocities.

FIGS. 12 to 14 show spectral progressions of signals acquired by the circuit according to FIG. 7 upon variation in the angle of incidence α with the respect to the line perpendicular to the target;

FIG. 15 shows a regression curve for α=25′;

FIG. 16 shows a curve for the frequency f₀ of the regression function;

FIG. 17 shows a regression curve for α=25° and velocity of the fluid equal to 17.5 cm/s.

FIG. 18 shows a calibration curve for α=25′;

FIG. 19 shows an apparatus which makes use of retroinjection interferometry according to the present invention;

FIG. 20 schematically illustrates operation of the apparatus according to FIG. 19;

FIG. 21 schematically shows an extracorporeal circuit comprising an apparatus according to the invention;

FIG. 22 schematically shows three different spectral progressions of signals acquired by the circuit according to FIG. 7.

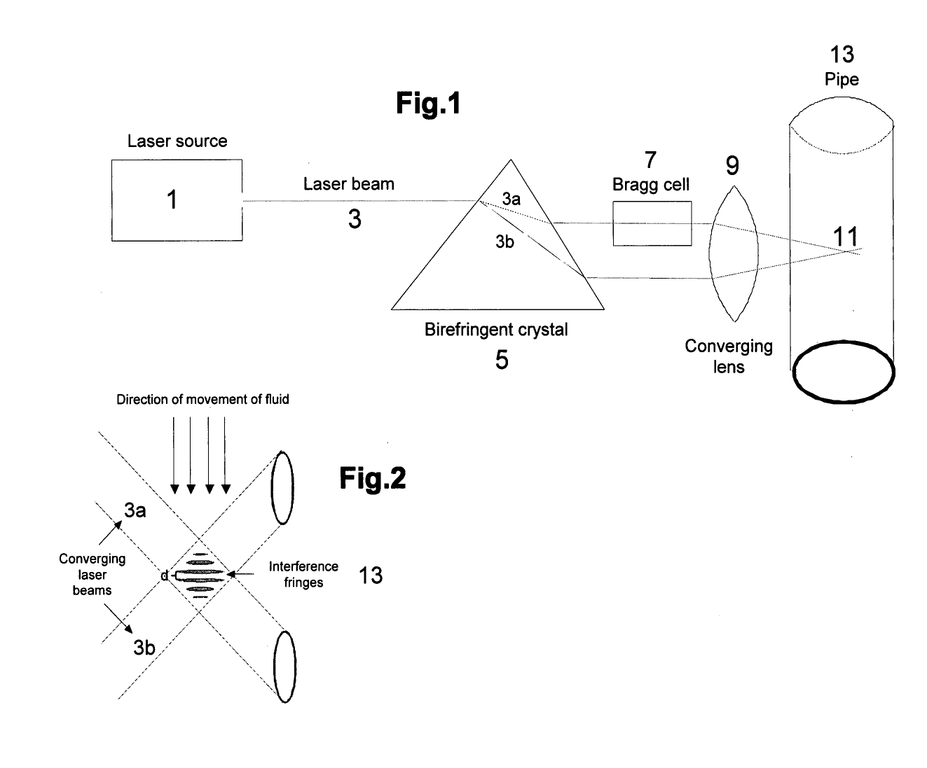

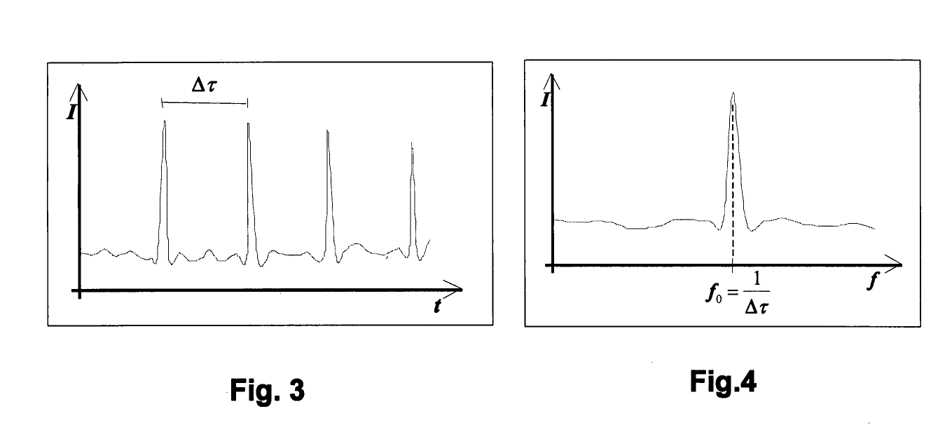

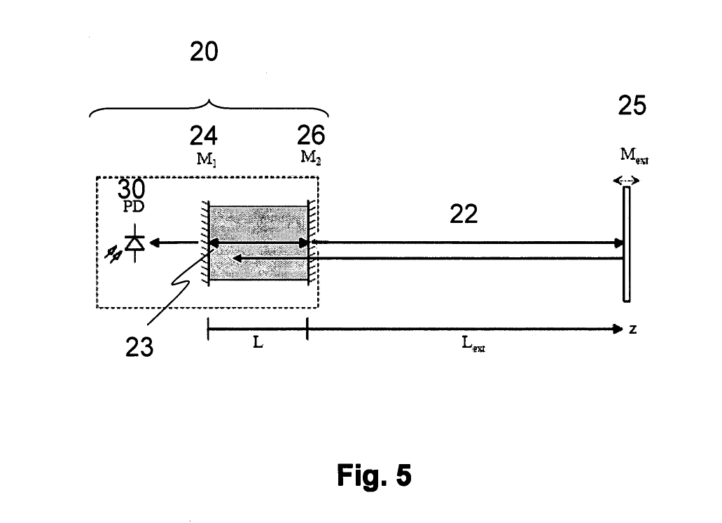

### DETAILED DESCRIPTION

The method according to the invention allows measurement of the mean velocity V_{H} of an extracorporeal blood fluid or infusion fluid 50 by means of retroinjection interferometry. In accordance with a general embodiment, the method comprises the steps of:

(a) preparing a pipe 48 comprising a flow of said fluid 50, said pipe 50 being part of an extracorporeal circuit 58 suitable for connection to a patient;
(b) emitting a first laser light beam 41 from the laser cavity 40 of a semiconductor laser source 60;
(c) directing said first laser beam 41 so as to strike said fluid 50;
(d) reflection of a second laser beam 45 by said fluid 50 and consequent generation of interference with said first laser beam 41 in said laser cavity 40;
(e) detection of the interference signal by a monitoring diode 46; and
(f) processing, by means of an electronic processing and control circuit 100, said detected interference signal.

The measurement system makes use of the Doppler principle in the field of electromagnetic waves in the ultraviolet, visible and near infrared ranges (UV-NIR), in particular using a laser source in the range of 250 to 1500 nm.

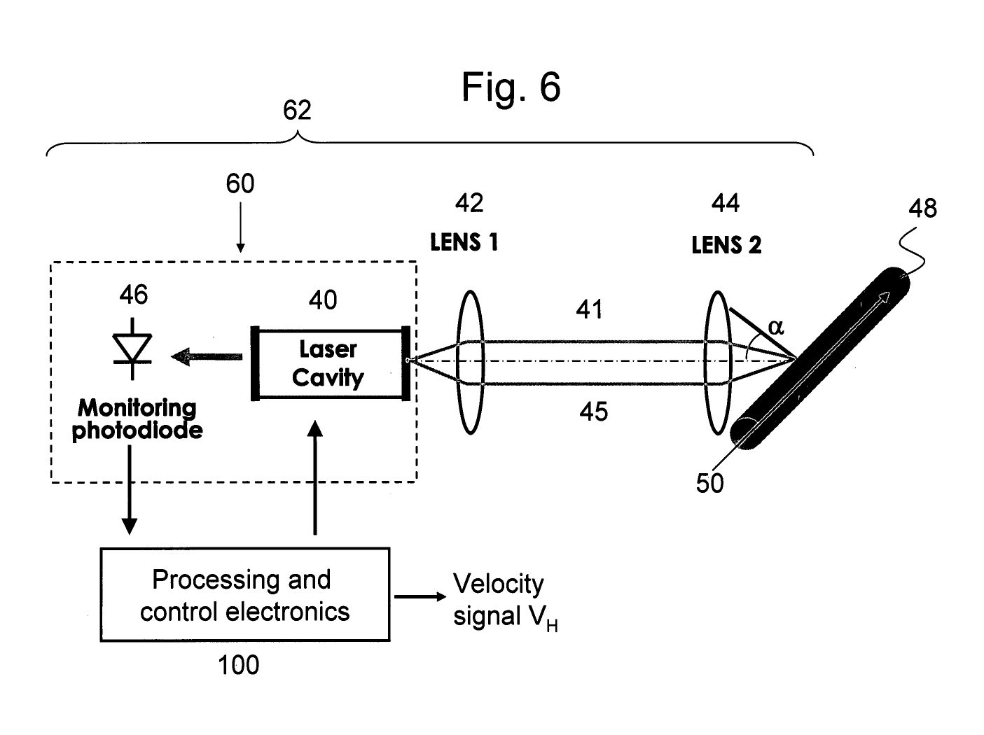

FIG. 6 shows a laser source 60 which comprises a laser cavity 40 for the generation of coherent electromagnetic waves; the source 60 emits a laser beam 41 towards a target (fluid 50 moving inside a pipe 48) which is reflected as a beam 45. This configuration forms a retroinjection interferometer which allows measurement of the Doppler shift of the backscattered radiation, resulting in an optical signal with a frequency proportional to the velocity of the fluid V_{f} at a given point.

In greater detail, the laser source 60 emits a laser beam 41 towards a system provided with means for processing the laser beam, said means comprising two lenses, i.e. a first collimation lens 42, which collects most of the power emitted by the laser source 60, and a second focusing lens 44, which optimizes focusing of the laser beam 41 on the moving fluid 50.

The choice of the two lenses is intended to maximize the power backscattered towards the laser cavity 40 and results in a significant reduction in the costs of the individual optical systems (two ordinary plastic lenses typically used to collimate laser diodes).

In a preferred embodiment the first lens 42 is a collimation lens with a focal length of 8 mm, which collects most of the power emitted by the laser 60, without the need for a high numerical opening (which is instead required for a single focusing lens) and generates a collimated beam with a diameter of about 3 mm. The focal length of the second lens 44, instead, is chosen depending on the pipe used. The best length is 8 mm, the same as that of the lens 42, since it allows good focusing of the laser beam within the fluid. In the case of pipes with diameters greater than 1 cm it is possible to use larger focal lengths which allow the focus of the beam to be positioned further inside the pipe itself. For example operation with a focal length of 18 mm was verified, this producing a geometric increase in the beam diameter or “beam waist” by a factor of about 2, with good signals still being obtained for most of the fluids which can be used.

The distance between the two lenses constitutes a degree of freedom in the mechanical design; in a possible embodiment it is equal to about 3 cm.

The choice of the laser source, on the other hand, was performed by means of various tests using several sources and the experimental results were used to select low-cost and widely available models.

Advantageously, according to the invention, the laser beam 41 strikes the fluid 50 at an angle of incidence α with respect to the line perpendicular to the pipe 48.

The angle α has an amplitude in the range of 10°<α<40°, the preferred amplitude being 30°.

The beam 41 is reflected by the fluid 50 towards the laser cavity 40 along a reflected beam 45, generating inside this cavity, and with the originally emitted beam 41, constructive or destructive interference depending on the phase of the retroinjected beam.

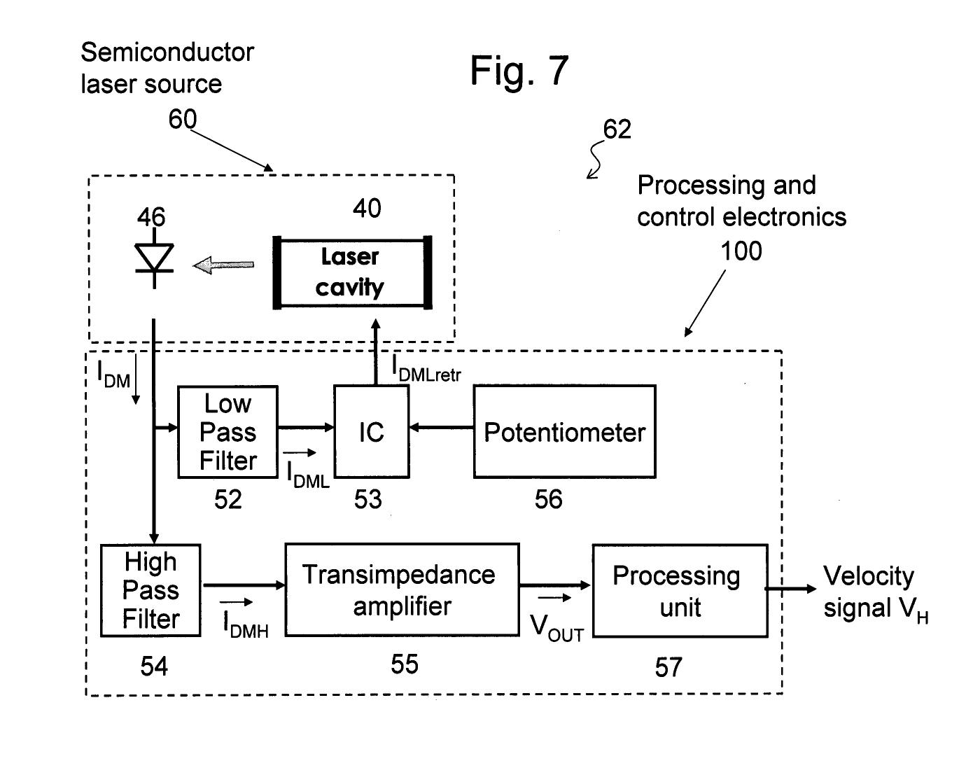

The generated interference signal is detected by the monitoring photodiode 46 and processed by a dedicated electronic processing and control circuit 100, the basic features of which are shown in FIG. 7. Generally, the circuit 100 receives at its input a current I_{DM} generated by the monitoring photodiode 46 and outputs a low-frequency current I_{DMLretr} fedback to the laser 60 and a signal V_{H} for the mean velocity of the fluid.

In greater detail, the circuit 100 measures the current I_{DM} generated by the monitoring photodiode and uses it for two purposes:
a continuous and low-frequency alternating component I_{DML} is discriminated by a low-pass filter 52 (which allows, for example, the frequencies lower than 1 kHz to pass through) and is used by an integrated circuit 53 for control of the mean power emitted by the laser 60, by means of variation of its supply current. The integrated circuit 53 generates a supply current I_{DMLretr} fedback to the laser 60 so as to keep the continuous component of the current of the monitoring photodiode 46 equal to a constant which can be set by means of a potentiometer 56.

The high-frequency alternating component I_{DMH} of the current I_{DM}, which is discriminated by a high-pass filter 54 (which allows, for example, frequencies higher than 1 kHz to pass through), is converted into a voltage Vₒᵤₜ by means of a transimpedance amplifier 55. The value of the mean velocity V_{H} of the fluid flowing inside the pipe 50 is obtained from the output signal Vₒᵤₜ, processed by a following processing unit 57.

In particular, the processing unit 57 performs initial processing of the signal Vₒᵤₜ by means of a fast Fourier transform (FFT), obtaining the centroid of the frequencies f̅ proportional to the measured velocity Vₘ which is the component of the velocity of the fluid V_{f} at a given point along the direction of the laser beam.

Since

Vₘ=V_{f}×sin(α) (1.5),

f̅ is expressed exactly as

f̅=V_{f}×sin(α)×2/λ (1.6)

where λ is the laser wavelength.

Since the velocity of the fluid is not uniform within the pipe cross-section, the signal Vₒᵤₜ obtained from (1.5) and (1.6) has a continuous frequency spectrum S which contains the information relating to the distribution of the velocity V_{f} in the pipe portion illuminated by the laser beam.

The second processing operation performed by the processing unit 57 is numerical in nature and is used to obtain the mean velocity V_{H} of the fluid from the frequency spectrum S of the signal Vₒᵤₜ, said frequency being, as already mentioned, proportional to the velocity of the fluid.

This numerical processing operation will be described in the section below which deals with the experimental tests.

The circuit 100 is designed for individual powering, is also particularly versatile and offers numerous advantages from a design point of view:
it may be used to power any type of semiconductor laser;
the transimpedance read circuit may be connected without problems to any monitoring photodiode, being designed to offer optimum stability for the typical capacitance values involved, i.e. 20 pF, but also being very stable for capacitance values of the monitoring photodiode higher than 50 pF; and
the introduction of a different laser diode (laser source) is very simple since the procedure is fast and easy to implement.

In fact, by means of the multi-revolution potentiometer 56 it is possible to regulate the continuous power P1 emitted by the laser. In the event of replacement of the laser (or change of model) it is merely required to perform a simple procedure involving calibration of the power supply current, which can be adjusted by means of said potentiometer 56, in order to obtain correct operation.

More specifically, when replacing the laser source 60, which operates using a current (I_{DM}), with a new laser source 70, which operates using a current (I_{DM1}), it is sufficient to calibrate the current I_{DMLretr} fedback to the new laser source (70), by means of operation of said potentiometer (56) which acts on said integrated circuit (53), so as to regulate the current input to the new source.

In a preferred embodiment, the circuit was set up according to the characteristics of the laser QL78J6SA and provided a measurement band at −3 dB of about 1 MHz, together with the values of the passive components used: a trans-resistance of 100 kΩ was used, sufficient for providing signals which can be measured by following processing electronics, for example that of the processing unit 57.

In order to perform optimum measurement of V_{f} the pipe 48 is preferably transparent and the fluid 50 itself should be sufficiently transparent, in order to be able to focus laser rays at different depths within the fluid.

It is also preferable that, within the fluid 50, there should be present suspended diffusive particles which reflect light if illuminated by the laser beam 41.

The flowrate of the fluid, i.e. the quantity of fluid which passes through a cross-section of area A per unit of time is obtained by means of the known equation:

Q=V_{f}×A

where A denotes the cross-sectional area of the pipe 48 which is passed through by the fluid and V_{f} was obtained as explained above.

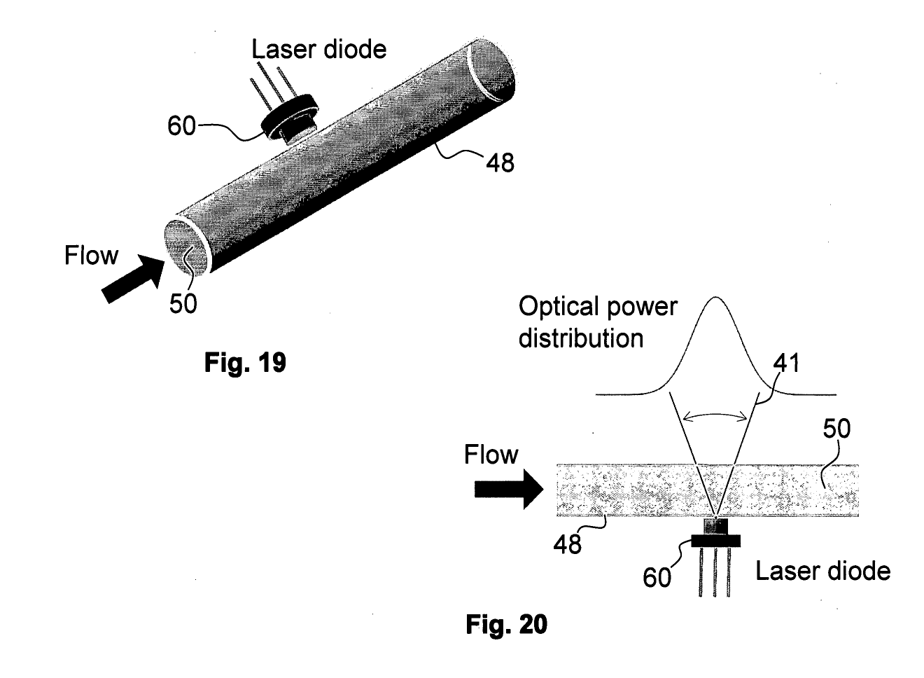

Another example of embodiment of the apparatus 62 according to the invention, shown in FIGS. 19 to 20, is described below. With regard to structural and functional aspects which are not explicitly described, it is understood that they are similar to those of the embodiment described above and reference should therefore be made to the corresponding description. In this case also, the laser source 40 comprises a laser cavity 60 for the generation of coherent electromagnetic waves; the source 41 emits a laser beam 50 towards the target (fluid 50 moving inside the pipe 48) and the laser beam 41 is reflected as a beam 45. This configuration also forms a retroinjection interferometer which allows measurement of the Doppler shift of the backscattered radiation, resulting in an optical signal with a frequency proportional to the velocity of the fluid V_{f}.

In greater detail, the laser source 60 emits a laser beam 41 which is not collimated. As is known, the laser beam 41 which is emitted from the laser cavity 40 may be described as a Gaussian beam. In other words, the laser beam 41 is not perfectly aligned along the optical axis of the source 60, but subtends a solid angle. Moreover, the distribution of the optical power of the laser beam 41 in a plane perpendicular to the optical axis follows a Gaussian distribution. The amplitude of the solid angle is typically in the range of between 10° and 30°. This condition is schematically shown in FIG. 20.

Unlike the apparatus 62 described above, in the embodiment shown in FIGS. 19 and 20 there are no means for processing the laser beam. In other words, no lens or no prism nor any other optical component able to modify the properties of the laser beam is provided between the source 60 and the pipe 48. In some embodiments, an ordinary glass element for protecting the source 60 is provided between the source 60 and the pipe 48. This glass element, when present, has the property of allowing the laser beam to pass through without substantially altering its characteristics. In this case, the possible contribution of each reflected laser beam 45 to calculation of the velocity of the fluid 50 depends on the angle which it forms with the line perpendicular to the velocity vector itself. In particular, the outermost laser rays form larger angles and provide a greater contribution, while the contribution of the central ray, which is perpendicular to the velocity vector, is zero. In the outer zones of the uncollimated laser beam, in view of the Gaussian distribution described above, the intensity of the laser beam is minimal. It must be considered, however, that the different contributions of the individual reflected laser rays 45 are added together so as to provide an optimum base for calculation of the velocity of the fluid 50.

In FIGS. 19 and 20, the laser source 60 is shown with the optical axis perpendicular to the pipe 48 and therefore to the velocity vector of the fluid 50. This geometric configuration is to be considered preferable, but tests have shown that other configurations also provided excellent results.

As described above, all the contributions of the different reflected rays, these contributions depending on the angle which they form with the line perpendicular to the velocity vector, are added together. The inclination of the optical axis with respect to the pipe 48 increases the contributions provided by the rays which are situated in an outer zone of the beam which is not collimated, compared to the rays which are situated in the diametrically opposite outer zone. In any case the sum of the different contributions still constitutes an optimum base for calculation of the velocity of the fluid 50.

### Experimental Tests

Measurements were carried out both on a water-based fluid with the addition of scattering particles and on blood.

The fluids were placed in motion at a controlled velocity, by means of a peristaltic or centrifugal pump, inside transparent plastic pipes with an internal diameter variable between 2 mm and 12.5 mm.

The mean velocity V_{H} of the fluid was obtained as the flowrate divided by the cross-section of the pipe.

The pumps used provided a flowrate which could be varied from zero to 8000 ml/min.

The figures below show the results obtained with flowrates of 450 ml/min in pipes with a diameter of 4.3 mm, which correspond to a mean velocity V_{H} of the fluid of about 45 cm/s.

The signal output by the transimpedance circuit was acquired using a digital oscilloscope (500 MHz band) on which the spectrum was calculated by means of a fast Fourier transform (FFT) then averaged out over 10 readings.

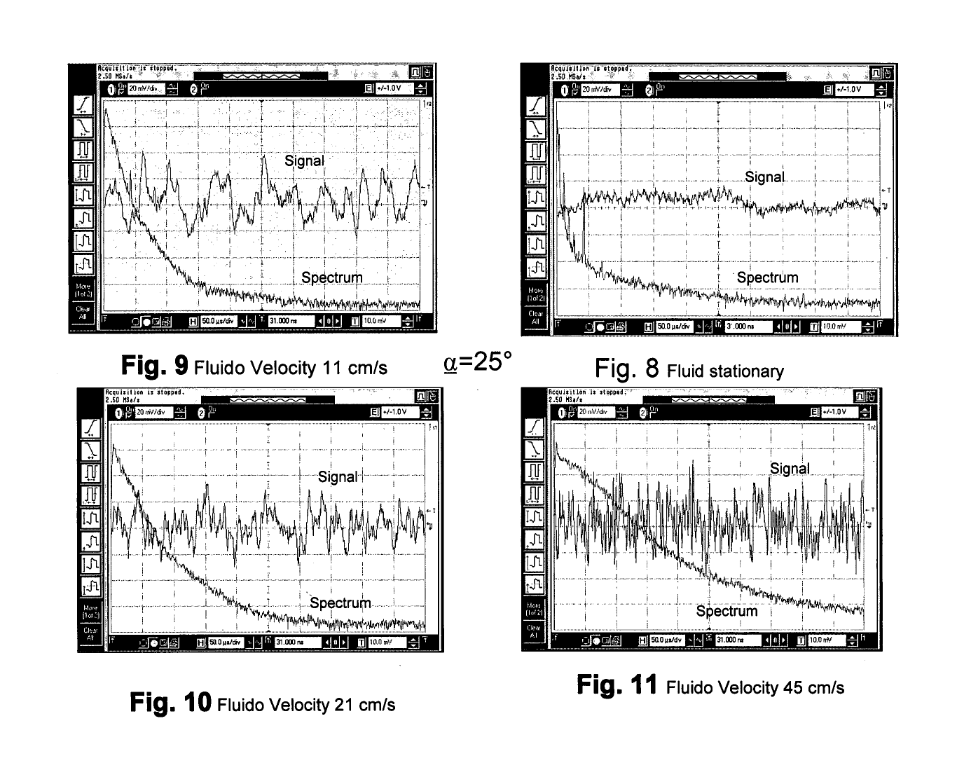

FIGS. 8 to 11 show a series of readings obtained for variation of the mean velocity V_{H} of the fluid, estimated on the basis of the flowrate measured, with inclination of the laser beam at α=25°.

The signal over time (20 mV/div, 50 μs/div) is indicated in the figures by “Signal”, while “Spectrum” represents its averaged spectrum, up to a band of 1.25 MHz (5 dB/div).

It may be noted that, with an increase in the mean velocity V_{H} of the fluid, i.e. viewing in sequence FIG. 8 (fluid stationary), FIG. 9 (fluid moving at 11 cm/s), FIG. 10 (fluid moving at 21 cm/s) and FIG. 11 (fluid moving at 45 cm/s), the signal acquires increasingly higher frequency components, as can be seen both from the power spectrum and from simple viewing of the reading over time. Owing to the reproducible nature of this phenomenon, it is possible to perform an optical measurement in real time of the flowrate.

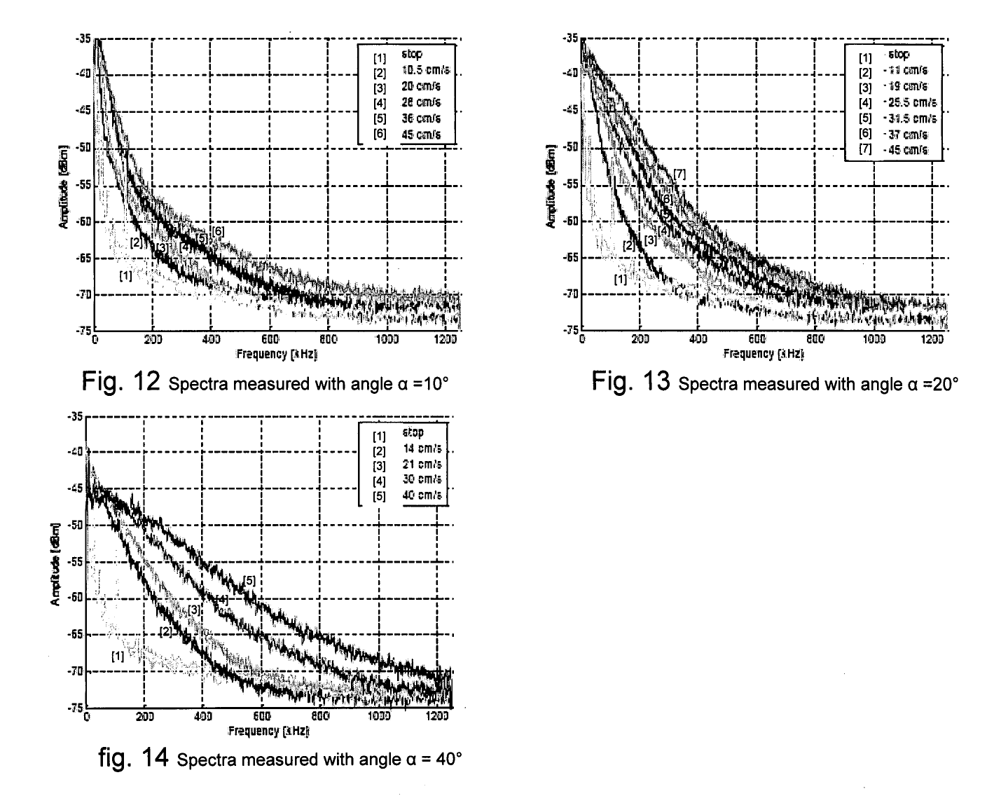

By modifying the angle of incidence of the laser light on the pipe it was possible to define the characteristics of the phenomenon, and the spectra of the signal obtained with angles α of 10°, 20° and 40° are shown respectively in FIGS. 12, 13 and 14, where the considered velocities relate to the spectra which are identified by the numbers in square brackets [1] to [7].

With an increase in the angle of inclination α, the frequencies increase (in keeping with theory) as sin(α), while the amplitudes of the signals tend to decrease, because the power backscattered in the direction of the laser decreases.

A good compromise for the measured velocities appears to be an angle of between 25° and 30°. If it were required to measure significantly higher velocities, smaller angles (for example 10°) would be chosen, these allowing the band of the electronics to be kept small. In the case of these angles, the signal exceeds by about 30 dB the background noise, facilitating both analog and digital processing. Once the spectrum of the signal output by the transimpedance circuit has been obtained, there exist several techniques for analysing the spectral data thus obtained, in order to arrive at the flow measurement.

A first analysis considers, for example, the power distribution F(f) of the spectrum S of the signal Vₒᵤₜ acquired by the processing unit 57, from where a behaviour similar to a “low pass” function is identifiable;

$$F ( f ) ∝ \frac{1}{1 + {f}^{2} / {f}_{0}^{2}}$$

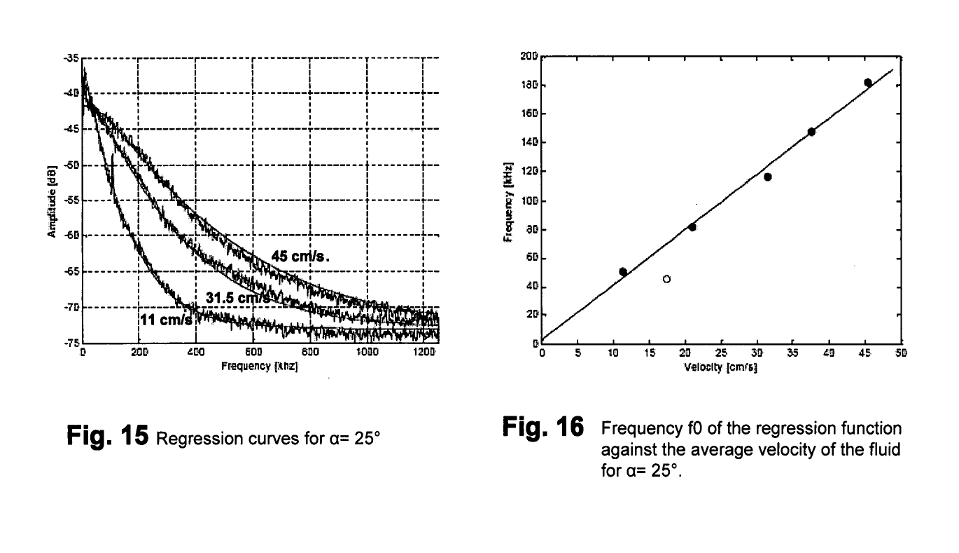

as may be noted from FIG. 15, which show the 3 measurements performed for α=25°, at 11 m/s, 31.5 m/s and 45 m/s, together with the corresponding least squares regression curves F obtained considering a constant background noise; this theoretical result is fully confirmed by the test results.

A method for processing the data consists in deriving the cut-off frequency f₀ of the regression curve. This frequency f₀ is proportional to the velocity of the fluid.

FIG. 16 shows the cut-off frequencies obtained for measurements with α=25°, there being in fact a fairly linear dependence of f₀ on the mean velocity V_{H} of the fluid.

This first processing method is fairly complex since it requires “least squares” recursive minimization of the distance in order to obtain the regression curve; moreover, the least squares method is extremely sensitive to variations of the very low frequency part of the signal, where the amplitude is maximum, such that a disturbance or fluctuation of the signal in this zone results in a significant degree of imprecision.

FIG. 17 shows a measurement for α=25°, represented as an empty circle in the graph of FIG. 16, since it is clearly incorrect owing to the vibrations of the pipe which have induced a strong signal at a low frequency, deceiving the least squares regression calculation and resulting in underestimation of the cut-off frequency.

A second analysis considers the frequency spectrum S of the signal Vₒᵤₜ as a probability density function (PDF) of the velocity of the particles suspended in the fluid, overcoming the drawbacks encountered in the first analysis.

This analysis is derived from the physical interpretation of the backscattering phenomenon: each particle backscatters in the laser cavity an electric field which produces a Doppler beat frequency which is proportional to its velocity; moreover, the contribution of each particle may be regarded as being unrelated to the others (hence the addition of the power). Hence the mean value may be determined as an expected value by the PDF p(x):

$$\overline{x} = {\int }_{0}^{\frac{{f}_{sampling}}{2}} p ( x ) \cdot x d x$$

In the case in question the centroid of the frequencies is calculated as:

$$\overline{f} = \frac{{\int }_{0}^{\frac{{f}_{sampling}}{2}} p ( f ) \cdot f \cdot d f}{{\int }_{0}^{\frac{{f}_{sampling}}{2}} p ( f ) \cdot d f} ≅ \frac{{\sum }_{0}^{\frac{{f}_{sampling}}{2}} S ( f ) \cdot f}{{\sum }_{0}^{\frac{{f}_{sampling}}{2}} S ( f )}$$

where f_{sampling} is the sampling frequency which is chosen according to the equation 1.6 which takes into account the wavelength of the laser used and the angle which forms the optical angle of the laser with respect to the direction of movement of the fluid and the velocity of the fluid itself; and
where S(f) is the vector which represents the power spectrum of the signal (square modulus of the vector obtained by the FFT operation). The centroid of the frequencies f̅ obtained is proportional to the mean velocity V_{H} of the fluid.

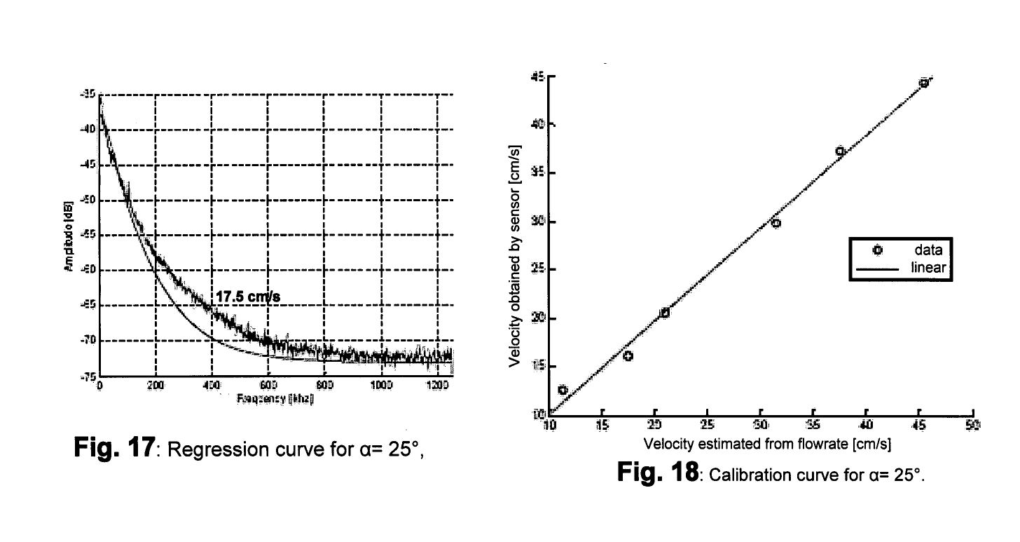

By means of this processing algorithm, which is extremely simple since it requires only two additions, the calibration curve shown in FIG. 18 is obtained, this curve containing all the measurement points performed for α=25°.

In reality the frequency power distribution does not represent exactly the velocity distribution of the particles in the fluid, since the contribution of each particle in the measurement system is weighted by the power which is backscattered in the laser cavity.

In addition to a stochastic distribution of the contributions, which for large numbers of particles would result in a correct average value, it is necessary to take into account the different attenuations affecting the reflections emitted from more internal portions of the pipe. Moreover, the position of the laser focus is of fundamental importance since it determines the position of the particles which will provide a greater contribution.

Experimental tests have shown that positioning the focus exactly on the edge of the flow provides the maximum signal, but at low frequencies, since the maximum illumination occurs on the particles near to the edges of the pipe which travel at a slower speed; thus there is less sensitivity at the higher velocities.

The optimum solution for positioning of the focus has proved to be about 2-3 mm inside the flow.

In this way the signal is not subject to marked attenuation with respect to the maximum value (about −3 dB), but much more signal is obtained at the high frequencies (containing the information about the velocity).

The measurements shown in FIGS. 12, 13 and 14 were carried out in this condition. To conclude, in order to obtain the exact measurement of the mean velocity of the fluid, it would be necessary to weight the individual frequency components by the inverse amount of the attenuation affecting them; it has been shown in tests, however, that a constant weighting factor (calibration of the system) is sufficient to provide a monotone measurement curve with good linearity (see FIG. 18) which may be easily used to perform measurement of the flowrate.

In accordance with another embodiment of the method according to the invention, the centroid of the frequencies is calculated as:

$$\overline{f} = \frac{{\int }_{0}^{{f}_{noise}} Log ( p ( f ) ) \cdot f \cdot d f}{{\int }_{0}^{{f}_{noise}} Log ( p ( f ) ) d f} ≅ \frac{{\sum }_{0}^{{f}_{noise}} Log ( S ( f ) ) \cdot f}{{\sum }_{0}^{{f}_{noise}} Log ( S ( f ) )}$$

where fₙₒᵢₛₑ is the frequency value at which the signal curve meets the noise curve.

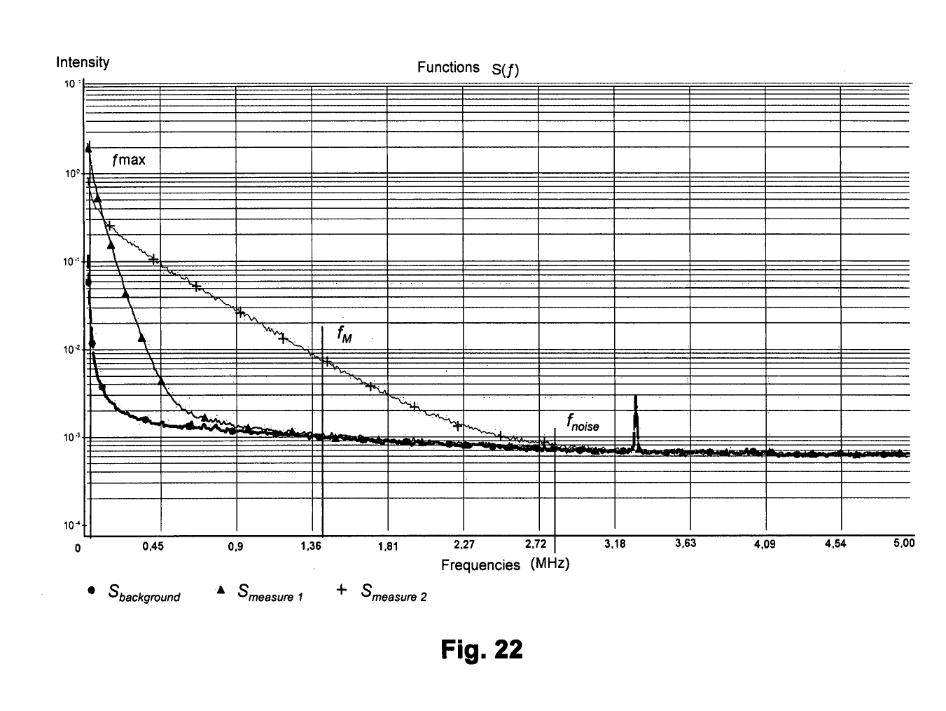

This processing algorithm is again extremely simple. However, owing to the introduction of the logarithm, it is able to confer automatically a greater weight to the high-frequency components, which contain most of the information useful for measurement of the velocity, thus filtering the components which are more easily disturbed by external factors. Obviously the power spectrum must be considered for as long as it continues to be significant, ignoring therefore the contributions due exclusively or almost exclusively to the background noise; the calculation of the power spectrum is in fact interrupted at the frequency fₙₒᵢₛₑ, which can be determined using different methods, for example using the following method (described with particular reference to FIG. 22):
With the fluid not in movement, the complete spectrum S_{background} of the signal Vₒᵤₜ acquired by the processing unit 57 is calculated “one off” for the background noise in the frequency range between 0 and

$$\frac{{f}_{sampling}}{2}$$

and the logarithm thereof is performed.
Digital filtering of the signal is performed (for example using the Savitzky-Golay filter) in order to remove the signal peaks due to disturbances.
The complete spectrum Sₘₑₐₛᵤᵣₑₘₑₙₜ of the signal Vₒᵤₜ acquired by the processing unit 57 at an unknown flowrate is calculated in the frequency range between 0 and

$$\frac{{f}_{sampling}}{2}$$

and the logarithm thereof is performed.
Digital filtering is performed as for the power spectrum of the background noise.
The following function is calculated:

L_{(measurement-background)}(f)=Log(Sₘₑₐₛᵤᵣₑₘₑₙₜ(f))−Log(S_{background}(f))
The maximum value of this function is determined:

L^{max}_{(measurement-background)}(f)
The frequency f_{M} is determined so that:

$${L}_{( measurement - background )} ( {f}_{M} ) = \frac{{L}_{( measuremrnt - background )}^{max} ( {f}_{M} )}{2}$$

the double frequency of the value f_{M} obtained is the value fₙₒᵢₛₑ.

However, since during calculation of the centroid of the frequencies the logarithm of the spectra must be calculated, during the noise subtraction operation values of less than 1 must not be obtained. For example, it is possible to avoid this situation by adding or subtracting a constant function K(f) such that:

L_{(measurement-background)}(f)±K(f)=1

for f=ₙₒᵢₛₑ.

In some embodiments, the apparatus 62 according to the invention assumes a so-called “stand-alone” form. Namely, it is able to operate independently of other apparatus. Typically, in accordance with this embodiment, the optical components and the electronic components are contained inside a housing suitable for ensuring safe use thereof, typically in hospital environments. The housing also has a seat for insertion of the pipe 48 which is typically a tube of the type commonly used for extracorporeal circuits. The pipe 48 may be for example a disposable polymer tube with an internal diameter of 2 mm to 12.5 mm. The optical components are arranged so as to emit the laser beam 41 towards the seat containing the pipe 48. The data processed by the circuit 100 of the apparatus 62 may be advantageously transmitted externally via standard communication means so as to facilitate interfacing with other equipment. The communication means for conveying data about the calculated velocity may, for example, make use of an ordinary USB (Universal Serial Bus) connection. This connection offers various advantages including the widespread use of this standard system and the possibility of being used also for powering the apparatus 62. Other communication means for conveying the data may be, for example, wireless means.

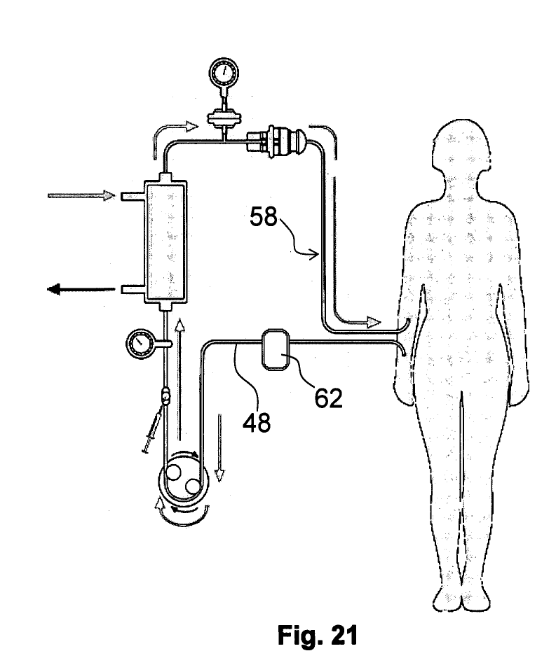

In accordance with other embodiments, the apparatus 62 is instead included in a more complex machine, such as a haemodialysis machine like the one shown schematically in FIG. 21.

Finally, the present invention relates to an extracorporeal circuit 58 (shown schematically in FIG. 21) comprising a pipe 48 inside which a physiological fluid 50 flows. The extracorporeal circuit 58 also comprises an apparatus 62 in accordance with that described above. The extracorporeal circuit 58 is suitable for connection to a patient, for example during therapeutic treatment which requires extracorporeal circulation. Some examples of this therapeutic treatment are haemodialysis, haemofiltration, haemodiafiltration, open-heart surgery, etc. Obviously, with regard to the embodiments of the method, the apparatus 62 and the extracorporeal circuit 58 described above, the person skilled in the art may, in order to satisfy specific requirements, make modifications to and/or replace elements described with equivalent elements, without thereby departing from the scope of the accompanying claims.

1. Method for measuring the mean velocity (V_{H}) of an extracorporeal blood fluid or infusion fluid (50) by means of retroinjection interferometry, comprising the steps of:
(a) preparing a pipe (48) comprising a flow of said fluid (50), said pipe (48) being part of an extracorporeal circuit (58) suitable for connection to a patient;
(b) emitting a first laser light beam (41) from the laser cavity (40) of a semiconductor laser source (60);
(c) directing said first laser beam (41) so as to strike said fluid (50);
(d) reflection of a second laser beam (45) by said fluid (50) and consequent generation of interference with said first laser beam (41) in said laser cavity (40);
(e) detection of the interference signal by a monitoring diode (46); and
(f) processing, by means of an electronic processing and control circuit (100), said interference signal detected.

2. Measuring method according to any one of the preceding claims, wherein said circuit (100) receives at its input a current (I_{DM}) generated by said monitoring photodiode (46).

3. Measuring method according to claim 2, wherein a continuous and low-frequency alternating component (I_{DML}) of said current (I_{DM}) is discriminated by a low-pass filter (52) for generation of a continuous current I_{DMLretr} suitable for being fedback to said laser source (60), and a high-frequency alternating component (I_{DMH}) of said current (I_{DM}) is discriminated by a high-pass filter (54) connected to the input of a transimpedance amplifier (55) for generation of a corresponding output voltage (Vₒᵤₜ), the spectrum S of which is proportional to a measured velocity (Vₘ) of said fluid (50).

4. Measuring method according to claim 3, wherein the measured velocity (Vₘ) of the fluid (50) is associated with said voltage (Vₒᵤₜ) by the equation f̅=Vₘ×2/λ, where (λ) is the wavelength of the laser (60).

5. Measuring method according to claims 3 and 4, wherein said centroid of the frequencies f̅ is obtained by means of a fast Fourier transform (FFT) of the voltage (Vₒᵤₜ) performed by a processing unit (57).

6. Measuring method according to any one of the preceding claims, wherein said measurement (V_{H}) is obtained by means of numerical processing by said processing unit (57) from said frequency spectrum (S), the frequency being proportional to said velocity measurement (V_{H}).

7. Measuring method according to the preceding claim, wherein, during said numerical processing operation, the power distribution F(f) of the spectrum S of the signal Vₒᵤₜ is assimilated to the “low-pass” function:
$$F ( f ) ∝ \frac{1}{1 + {f}^{2} / {f}_{0}^{2}}$$
in which the frequency f₀ is proportional to said velocity measurement V_{H}.

8. Measuring method according to claim 6, wherein, during said numerical processing operation, the frequency spectrum S of the signal Vₒᵤₜ is regarded as a probability density function (PDF) of the velocity (V_{H}) of the particles suspended in the fluid, such that the mean frequency, proportional to said velocity V_{H}, is obtained as follows:
$$\overline{f} = \frac{{\int }_{0}^{\frac{{f}_{sampling}}{2}} p ( f ) \cdot f \cdot d f}{{\int }_{0}^{\frac{{f}_{sampling}}{2}} p ( f ) \cdot d f} ≅ \frac{{\sum }_{0}^{\frac{{f}_{sampling}}{2}} S ( f ) \cdot f}{{\sum }_{0}^{\frac{{f}_{sampling}}{2}} S ( f )}$$

9. Measuring method according to claim 6, wherein, during said numerical processing operation, the frequency spectrum S of the signal Vₒᵤₜ is regarded as a probability density function (PDF) of the velocity (V_{H}) of the particles suspended in the fluid, such that the mean frequency, proportional to said velocity V_{H}, is obtained as follows:
$$\overline{f} = \frac{{\int }_{0}^{{f}_{noise}} Log ( p ( f ) ) \cdot f \cdot d f}{{\int }_{0}^{{f}_{noise}} Log ( p ( f ) ) d f} ≅ \frac{{\sum }_{0}^{{f}_{noise}} Log ( S ( f ) ) \cdot f}{{\sum }_{0}^{{f}_{noise}} Log ( S ( f ) )}$$
where fₙₒᵢₛₑ is the frequency value at which the spectrum of the signal S is equal to the noise spectrum.

10. Measuring method according to the preceding claim, wherein fₙₒᵢₛₑ is calculated by means of the following steps:
calculation, with the fluid (50) stationary, of the complete spectrum S_{background} of the signal Vₒᵤₜ acquired by the processing unit (57), for the background noise in the frequency range between 0 and
$$\frac{{f}_{sampling}}{2} ;$$
calculation of the logarithm of S_{background};
digital filtering of S_{background} so as to remove the signal peaks due to disturbances;
calculation, with an unknown flowrate of the fluid (50), of the complete spectrum Sₘₑₐₛᵤᵣₑₘₑₙₜ of the signal Vₒᵤₜ acquired by the processing unit (57) in the frequency range between 0 and
$$\frac{{f}_{sampling}}{2} ;$$
calculation of the logarithm of Sₘₑₐₛᵤᵣₑₘₑₙₜ;
digital filtering of Sₘₑₐₛᵤᵣₑₘₑₙₜ so as to remove the signal peaks due to disturbances;
calculation of the function
L_{(measurement-background)}(f)=Log(Sₘₑₐₛᵤᵣₑₘₑₙₜ(f))−Log(S_{background}(f))
calculation of the maximum value of this function
L^{max}_{(measurement-background)}(f)
calculation of the frequency f_{M} so that:
$${L}_{( measurement - background )} ( {f}_{M} ) = \frac{{L}_{( measuremrnt - background )}^{max} ( {f}_{M} )}{2}$$
the value fₙₒᵢₛₑ is double the value f_{M}.

11. Method in accordance with the preceding claim, wherein digital filtering of the spectra S_{background}, Sₘₑₐₛᵤᵣₑₘₑₙₜ, comprises a Savitzky-Golay filtering step.

12. Method according to any one of claims 9 to 11, also comprising the step of adding or subtracting from L_{(measurement-background)} a constant function K(f) such that:
L_{(measurement-background)}(f)±K(f)=1
for f=fₙₒᵢₛₑ.

13. Apparatus (62) for measuring the velocity (V_{H}) of an extracorporeal blood fluid or infusion fluid (62), for implementing the method according to claims 1 to 12 comprising:
a semiconductor laser source (60) able to emit a first laser beam (41) and comprising a laser cavity (40); and
a fluid (50) in movement inside a pipe (48) which is struck by said first laser beam (41), said pipe (48) forming part of an extracorporeal circuit (58) suitable for connection to a patient;
said first laser beam (41) striking said fluid (50) so as to allow reflection of said first laser beam (41) along a second laser beam (45) and consequent generation of a signal interfering with said first laser beam (41) in said first laser cavity (40).

14. Apparatus (62) according to claim 13, wherein said laser source (60) further comprises a monitoring photodiode (46) for detecting said interference signal.

15. Apparatus (62) according to claim 13 or 14, further comprising an electronic processing and control circuit (100) for processing said interference signal detected.

16. Apparatus (62) according to claim 15, wherein said circuit (100) comprises:
a low-pass filter (52) able to receive at its input a current (I_{DM}) output by said monitoring photodiode (46) so as to cut off its high frequencies and generate a low-frequency alternating current (I_{DML});
a high-pass filter (52) able to receive at its input a current (I_{DM}) output by said monitoring photodiode (46) so as to cut off its low frequencies and generate a high-frequency alternating current (I_{DMH}).

17. Apparatus (62) according to claim 16, wherein said circuit (100) comprises an integrated circuit (53) which is able to receive, at its input, said low-frequency current (I_{DM}) and generate, at its output, a low-frequency current (I_{DMLretr}) fedback to the laser source (60).

18. Apparatus (62) according to claim 17, wherein said circuit (100) comprises a potentiometer (56) able to act on said integrated circuit (53) so as to regulate said current (I_{DMLretr}) fedback to the laser source (60).

19. Apparatus (62) according to any one of the claims 15 to 18, wherein said circuit (100) further comprises a transimpedance amplifier (55) able to receive at its input said high-frequency alternating component (I_{DMH}) of said current (I_{DM}) and generate an output voltage (Vₒᵤₜ).

20. Apparatus (62) according to claim 19, wherein said circuit (100) comprises a processing unit (57) able to perform signal processing, via FFT, of said voltage (Vₒᵤₜ), thus generating a frequency spectrum S.

21. Apparatus (62) according to claim 20, wherein said processing unit (57) is able to perform numerical processing of said frequency spectrum S so as to obtain a value of the mean velocity of the fluid (V_{H}).

22. Method for replacing the laser source (60) which operates using current (I_{DM}) with a new laser source (70) which operates using current (I_{DM1}), in the apparatus (62) according to claims 13 to 21 for implementing the method according to claims 1 to 12,
comprising the steps of:
removing said laser source (60)
inserting said new said laser source (70)
characterized in that it comprises the step of:
calibrating said current (I_{DMLretr}) fedback to said new laser source (70), by means of operation of said potentiometer (56) acting on said integrated circuit (53), so as to regulate the current input to the source so that it changes from the old value (I_{DM}) to the new value (I_{DM1}).

23. Extracorporeal circuit (58) comprising a pipe (48) comprising a flow of physiological fluid (50), and an apparatus (62) according to any one of claims 13 to 21, said extracorporeal circuit (58) being suitable for connection to a patient.
